(19) United States
(12) Patent Application Publication
(10) Pub. No.: US 2013/0095915 A1
(43) Pub. Date: Apr. 18, 2013

(54) GAMING CARD PROCESSING DEVICE ENABLING THE FIRST-IN-FIRST-OUT MANAGEMENT OF REWRITABLE CARDS

(71) Applicant: Kook-Ho Park, Gyeonggi-do (KR)

(72) Inventor: Kook-Ho Park, Gyeonggi-do (KR)

(21) Appl. No.: 13/805,564

(22) PCT Filed: Nov. 24, 2010
(86) PCT No.: PCT/KR2010/008359

§ 371 Date: Jan. 4, 2013

(30) Foreign Application Priority Data
Jun. 24, 2010 (KR) 10-2010-0059822

(51) Int. Cl. G07F 17/32

(52) U.S. Cl. CPC G07F 17/3251
USPC 463/25

(57) ABSTRACT

A gaming card processing device for improving the efficiency of card management and operation management by being configured to have an arrangement whereby a card which is collected first is issued first when collecting and issuing cards; and a card issuing and collection device for the card processing device. The processing device is configured such that a card which is collected first is issued first when collecting and issuing cards, which improves the efficiency of card management and operation management by equalizing the frequency of card use. The processing device can prevent machine errors and enhance reliability by having only one card, not a plurality of cards, issued at the time of card issue. The processing device can maintain the normal state of a machine by eliminating erroneous cards quickly when circumstance such as card jam, data recording error and card recognition failure occur at the time of card issue or collection.

### TECHNICAL FIELD

The present invention relates to a gaming card processing device, and more particularly, to a rewritable gaming card processing device which is configured to have an arrangement whereby a rewritable card which is collected first is issued first when collecting and issuing cards, namely a first-in-first-out (FIFO) arrangement.

### BACKGROUND OF THE INVENTION

Recent trend shows that casinos are being developed into a general recreation center based on the new concept of combining various types of entertainment with tourism. As a consequent, casino industry provides such positive effects as earning foreign currencies and tourism receipts, development and promotion of regional economy.

Since the gaming machines in casinos use coins, many coins are inserted into the coin box of a gaming machine during gaming and then discharged for returning when the game is finished. However, when the coin box becomes full or empty, the user cannot continue gaming and has to wait for service or move to anther gaming machine, which is a negative feature for user convenience and operational efficiency.

In addition, the coin handing devices forced to increase the size of gaming machines, and the frequent replenishment and collection of coins have been the burdens on operation and management.

To solve these problems, a technology using thermal paper tickets which are printed with bar codes, pertinent information, and value. These paper tickets may solve the problem of having to stop gaming when coins are exhausted. Also, the users need not touch contaminated coins, and the tickets are reusable within 30 days and cashed as necessary. However, paper tickets are stacked in the ticket box of a ticket printer by about 200-300 sheets, and require reloading when exhausted and an additional device for printing and issuing the tickets, and are weak to physical impact since they are made of paper.

In addition, issued paper tickets are stacked after being inspected in bill recognizers for reuse, resulting in shortened replacement period of bill stack boxes.

Recently, to solve these problems, a technology using rewritable cards has been developed, which are made of highly-durable PET or PVC material and may be used repeatedly by printing and erasing information on the surface, namely re-writable cards.

Rewritable cards have a layered structure comprising a base film, a rewritable record layer which may be colored and discolored by chemical reactions, and a protective layer on top, to enable repeated use by recording and erasing information with heat.

Korean Patent Laid-open Publication No. 10-2009-0082049 filed by the inventor of the present invention discloses a device having the functions of issuing and collecting cards and a method of issuing and collecting cards.

However, the conventional card processing devices are configured in an arrangement wherein the card collected first is issued last, namely, last-in-first-out (LIFO), leading to unequal number of use of the cards and low efficiency of card management.

### SUMMARY OF THE INVENTION

### Technical Problem

To solve the above described problems, the present invention provides a gaming card processing device which is configured such that a card collected first is issued first when collecting and issuing cards, namely a first-in-first-out (FIFO) arrangement, and hence has the effect of improving the efficiency of card management and operation management by equalizing the frequency of card use.

### Technical Solution

To solve the above mentioned problems, a gaming card processing device in accordance with the present invention includes:

a card input and output portion;
a data processing portion which records data onto the cards;
a printing and erasing portion which prints and erases data on the cards;
a card transfer portion which transfer the cards;
a controller which controls the operation of the device; and
a card stacking portion which delivers stacked cards and stacks collected cards.

The data processing portion may further include;

a barcode reader which is configured to read the barcodes marked on one side of the cards;
a magnetic stripe processor which is configured to write data on the magnetic stripes attached on one side of the cards and read and erase the data; and
a radio frequency processor which is configured to record data in the IC chips embedded in the cards and read and erase the data.

The card sacking portion may further include:

a mounting frame positioned behind the printing and erasing portion;
a card stacking box installed on the mounting frame in a detachable manner, attacked with cards inside, formed with
a discharge slot in the bottom front for discharging cards, and formed with an entry slot in the upper front for collecting cards;
a card transfer unit, for issuing cards, placed beneath the card stacking box to transfer the card at the bottom of the card stacking box to the card input and output portion; stoppers positioned in front of the card stacking box to allow only a single card is delivered;
a first deflector which is shaft-coupled to the mounting frame in a rotatable manner in order to guide the card issued by the card transfer unit to the card input and output portion;
a second deflector contacting the upside of the first deflector and shaft-coupled to the mounting frame in a rotatable manner to enable the collected cards stacked on top of the card stacking box through the entry slot; and
a card transfer unit, for collecting cards, which is shaft-coupled to the inner side of the mounting frame in a rotatable manner in order to transfer the card guided by the second deflector to stack the card on top of the card stacking box through the entry slot.

The transfer unit for issuing cards may further include:

a main feeding roller which is shaft-coupled to the mounting frame in a rotatable manner;
a sub-feeding roller which is shaft-coupled to the mounting frame in a rotatable manner maintaining a constant gap from the feeding roller;
a transfer belt connecting the main feeding roller and the sub-feeding roller;
a first pulley mounted fixedly at the end of the main feeding roller;
a drive motor installed fixedly on the mounting frame;
a second pulley installed fixedly to the rotating shaft of the drive motor; and
a connecting belt connecting the first and second pulleys.

The card transfer unit for collecting cards may further include:

a first transfer roller for colleting cards, connected to the shaft of the second deflector;
a second transfer roller for collecting cards, wherein the roller is shaft-couple to the inner side of the mounting frame in a rotatable manner at a certain gap with the first transfer roller for collecting cards;
a third transfer roller for collecting cards, wherein the roller is shaft-couple to the inner side of the mounting frame in a rotatable manner at a certain gap with the first transfer roller for collecting cards and close to the entry slot of the card stacking box;
a fourth transfer roller for collecting cards, wherein the roller is shaft-couple to the inner side of the mounting frame in a rotatable manner at a certain gap with the third transfer roller for collecting cards;
a feeding belt connecting the first transfer roller for collecting cards and the third transfer roller for collecting cards; and
a drive unit driving the first, second, third and fourth transfer rollers for collecting cards.

Inside the mounting frame is provided with the sensors detecting the position of cards being issued or collected and the sensors monitoring the level of the cards in the card stacking box.

An erroneous card removal unit may be further provided to remove the erroneous cards which may occur in the process of issuing or collecting cards.

The erroneous card removal unit may further include: an erroneous card stacking box positioned beneath the mounting frame to stack erroneous cards;

a solenoid installed on the lateral side of the mounting frame, controlled by the controller to guide the erroneous cards into the erroneous card stacking box by rotating the first deflector upwards centering the shaft; and
a pair of erroneous card transfer rollers which are shaft-coupled to the inside of the mounting frame in a rotatable manner, in order to transfer the erroneous cards, which are guided to the erroneous card stacking box by the solenoid, into the erroneous card stacking box.

Inside the mounting frame is provided with the sensors detecting the position of the erroneous cards being collected and the sensors monitoring the level of the cards in the erroneous card stacking box.

The stoppers consist of first, second, and third stoppers in front of the card stacking box so that the cards may be fed one by one, without overlapping, from the card stacking box to the card input and output portion.

The first deflector is driven up and down by a solenoid and the second deflector is mounted elastically with a spring.

The card stacking portion functions as a component of the gaming card processing device and so configured as to be usable as an independent card issuing/collecting device (card dispenser).

### Advantageous Effects

As described above, the present invention is configured such that a card which is collected first is issued first when collecting and issuing cards, and hence has the effect of improving the efficiency of card management and operation management by equalizing the frequency of card use.

Also, the present invention may prevent machine errors and enhance the reliability of the product by having only one card, not a plurality of cards, issued (passed through) at the time of card issuing.

Also, the present invention may maintain the normal state of machine by eliminating erroneous cards quickly when a circumstance such as card jam, data recording error and card recognition failure occurs at the time of card issuing or collection.

### BRIEF DESCRIPTION OF THE DRAWINGS

FIG. 1 is a block diagram of a gaming card processing device in accordance with the present invention,

FIG. 2 is a front perspective view of a gaming card processing device in accordance with the present invention,

FIG. 3 is a rear perspective view of a gaming card processing device in accordance with the present invention,

FIG. 4 is a perspective view of the main body of a gaming card processing device in accordance with the present invention,

FIG. 5 is a bottom perspective view of the cover of a gaming card processing device in accordance with the present invention,

FIG. 6 is a partially exploded perspective view of the card stacking portion of a gaming card processing device in accordance with the present invention,

FIG. 7 is an assembled perspective view of the card stacking portion of a gaming card processing device in accordance with the present invention,

FIG. 8 is a rear perspective view of the card stacking portion of a gaming card processing device in accordance with the present invention,

FIG. 9 is a cross sectional view of the card stacking portion of a gaming card processing device in accordance with the present invention,

FIGS. 10 and 11 are cross sectional views illustrating the operation of the erroneous card control unit in accordance with the present invention,

FIGS. 12 to 16 are views illustrating the issuing of cards,

FIGS. 17 to 19 are views illustrating the collection of cards,

FIGS. 20 to 22 are views illustrating the removal of erroneous cards, and

FIG. 23 is a flow chart explaining the card issuing and collection method in accordance with the present invention.

### DESCRIPTION OF THE MAJOR PARTS OF THE DRAWINGS

100: Card stacking portion
110: Mounting frame
120: Card stacking box
120a, 120b: Sensors
121: Discharge slot
122: Entry slot
130: Transfer unit for issuing cards
130: Transfer unit for issuing cards
131: Main feeding roller
132: Sub-feeding roller
133: Transfer belt
134: First pulley
136: Second pulley
137: Connection belt
141, 142, 143: Stoppers
151, 152: First and second deflectors
160: Transfer unit for collecting cards
161: First transfer roller for collecting cards
162: Second transfer roller for collecting cards
163: Third transfer roller for collecting cards
164: Fourth transfer roller for collecting cards
165: Feeding belt
166: Drive unit
180: Erroneous card removal unit
200: Card input/output portion
300: Data processing portion
400: Printing and erasing portion
500: Controller
600: Card transfer portion
700: Guide
800: Position controller
1000: Gaming card processing device
1000a: Main body
1000b: Cover

### DETAILED DESCRIPTION OF THE INVENTION

Preferred embodiments of the present invention will be described in detail with reference to the accompanying drawings.

Referring to the accompanying drawings, a gaming card processing device 1000 may issue and collect printable and erasable cards (i.e., cards applied with a thermal printing layer on a side) in so called first-in-first-out (FIFO) system in which the card first collected is re-issued for the first.

The gaming card processing device 1000 in accordance with the present invention includes a card input and output portion 200, a data processing portion 300, a printing and erasing portion 400, a controller 500, a card transfer portion 600, and a card stacking portion 100 which stacks input cards and collects collected cards.

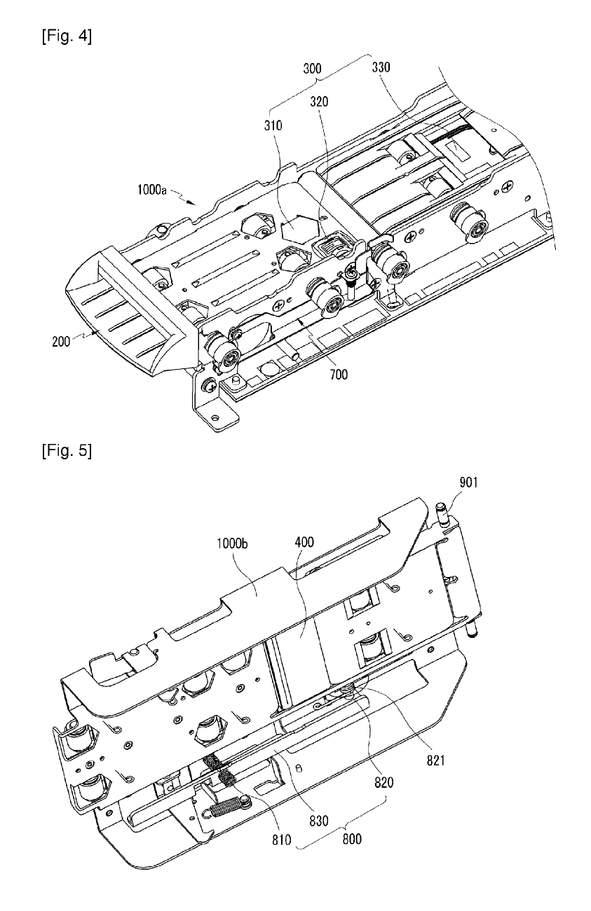

In addition, the gaming card processing device 1000 in accordance with the present invention may further include a guide part 700 and a position controller 800 for controlling the position of the printing and erasing portion 400 (see FIGS. 4 and 5).

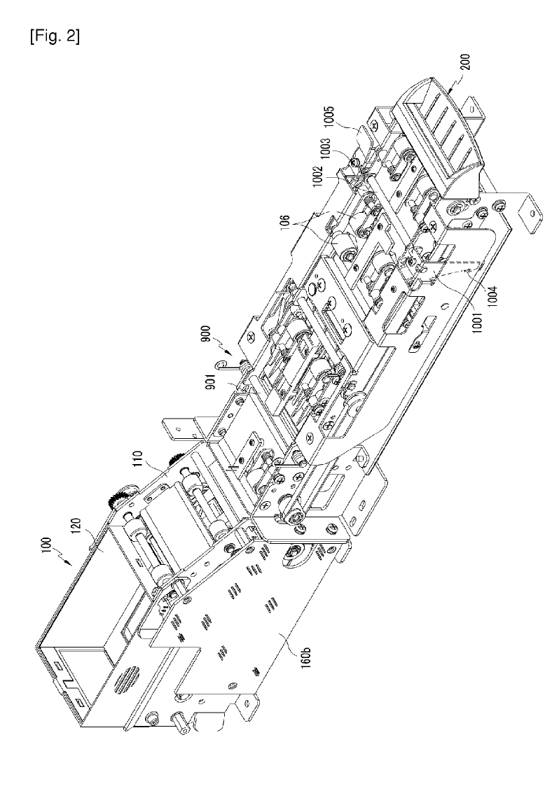

The gaming card processing device 1000 in accordance with the present invention is formed with a main body 1000a which provides the transfer path of cards and a cover 1000b coupled with the main body 1000a and may be opened and closed (see FIG. 2).

The card input and output portion 200, data processing portion 300, controller 500, and card transfer portion 600 are installed in the main body 1000a of the gaming card processing device 1000, and the printing and erasing portion 400 is installed inside the cover 1000b.

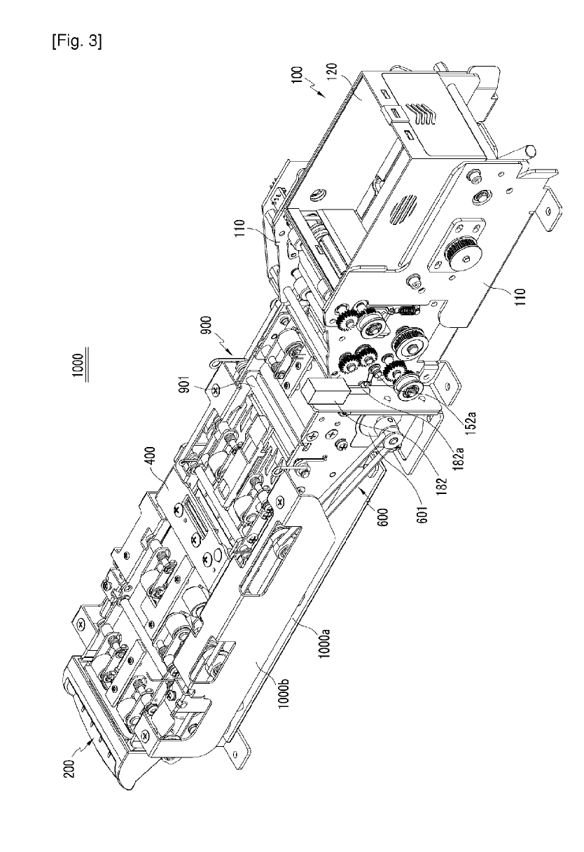

One side (fixed end) of the cover 1000b is shaft-coupled 901 to one side of the main body 1000a via a cover connector 900, and the opposite side (free end) of the cover 1000b is so configured as to be rotatable centered on the cover connector 900 (see FIGS. 2 and 3).

At the free end of the cover 1000b, a rotatable hook 1001 is shaft-coupled 1002 in a rotatable manner, and the shaft 1002 is provided with a torsion spring 1003.

When the rotatable hook 1001 is caught by the hook protrusion 1004, the cover 1000b keeps covering the main body 1000a, and when the rotatable hook 1001 is released from the hook protrusion 1004 by a knob 1005, the cover 1000b may rotate (open up) centered on the cover connector 900.

The cover 1000b is provided with a plurality of card transfer rollers 106, and the gaming card processing device 100 operates with the cover 1000b closed (see FIG. 3).

The card input and output portion 200 discharges issued cards out or receives used cards from outside.

The data processing portion 300 is so configured as to record information on the cards received from the card stacking portion 100, or read, change or delete the information on the cards transferred from the card input and output portion 200. The data processing portion 300 further includes a barcode recognizer 310, a magnetic stripe processor 320, and a radio frequency processor 330.

The barcode recognizer 310 recognizes the barcodes formed on one side of the cards, and the magnetic stripe processor 320 records data on the magnetic stripes formed on one side of the cards, and read or delete the data.

In addition, the radio frequency processor 330 is configured to record data in the IC chips embedded in the cards and read and erase the data.

According to the type of card, the data of the cards formed with barcodes are read by the barcode recognizer 310 of the data processing portion 300, the data of the cards formed with magnetic stripes are written, read and deleted by the magnetic stripe processor 320, and the data of the cards embedded with IC chips are written, read and deleted by the radio frequency processor 330.

The cards are formed with barcodes and magnetic stripes, and embedded with IC chips, respectively. According to the type of the cards, the functionality of the data processing portion 300 may be limited to processing a single type of cards or extended to process two or three types of cards simultaneously.

Apparently, the gaming card processing device 1000 in accordance with the present invention may process one or more types of cards made of paper, PET, PVC or other appropriate materials in different thicknesses, and provided with barcodes on one side, magnetic stripes on one side, or radio frequency cards embedded with IC chips inside.

The data processing portion 300 processes the data of these different types of cards with the bar code recognizer 310, magnetic stripe processor 320 and/or radio frequency processor 330.

Referring to FIG. 5, the position controller 800 is provided with a bar 830 coupled and interlinked with a thermal printer head 400, a hinge 820 connected to the bar 830 and provides the bar 830 with the force to turn towards the main body 1000a, and a spring 810 connected to the bar 830 and presses the bar 830 towards the main body 1000a.

The position controller 800 is coupled with the thermal printer head 400 which applies heat to thermal printing layer and controls the position of the thermal printer head 400.

By controlling the position of the thermal printer head using the position controller 800, the contact between the thermal printer head and the surface of the card to be printed may be controlled optimally to achieve constant printing quality for the cards of different thicknesses (0.2 mM-0.8 mM).

During printing or erasing operation, the thermal printing head 400 contacts the card by the spring 810 coupled with the bar 830 of the position controller 800 and the hinge 820 provided with the spring 821, which are so configured as to have the printer head press the card elastically.

The card stacking portion 100 of the gaming card processing device 1000 in accordance with the present invention is described in detail hereinbelow.

The card stacking portion 100 functions as a component of the gaming card processing device and so configured as to be usable also as an independent card issuing/collecting device (card dispenser).

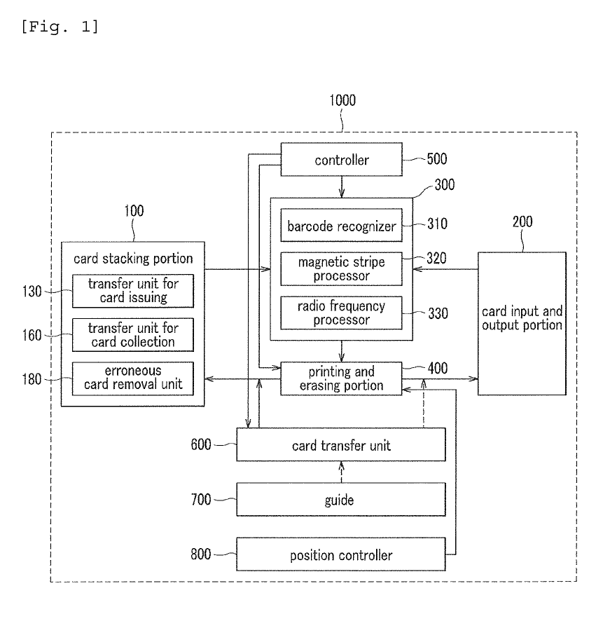

The card stacking portion 100 is configured to stack the cards to be issued, collect, initialize and stack the used cards to be ready to be issued again, comprising a mounting frame 110, a card stacking box 120, a transfer unit 130 for issuing cards, stoppers 141, 142, and 143, first and second deflectors 151 and 152, a transfer unit 160 for collecting cards, sensors 110a, 110b, 110c, 120a, and 120b, and an erroneous card removal unit 180 which removes erroneous cards which may be produced in the process of card issuing and collecting (see FIG. 1).

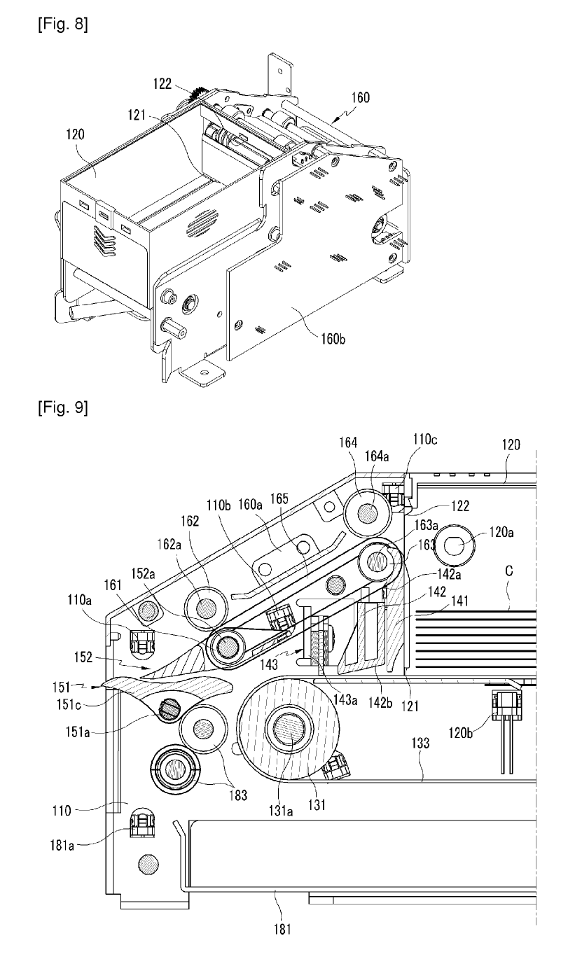

The card stacking portion 100 is provided with a mounting frame 110. The card stacking box 120 is installed at the rear upper position of the mounting frame 110. A plurality of cards (C) are stacked in the card stacking box 120. At the front lower part of the card stacking box 120 is formed with a discharge slot 121 for discharging cards and at the front upper part is formed with an entry slot 122 for collecting cards (see FIG. 8).

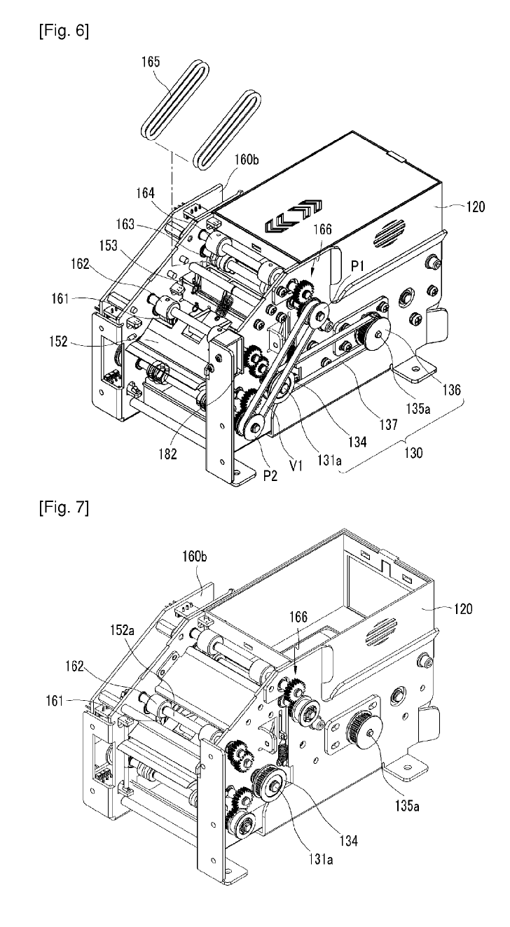

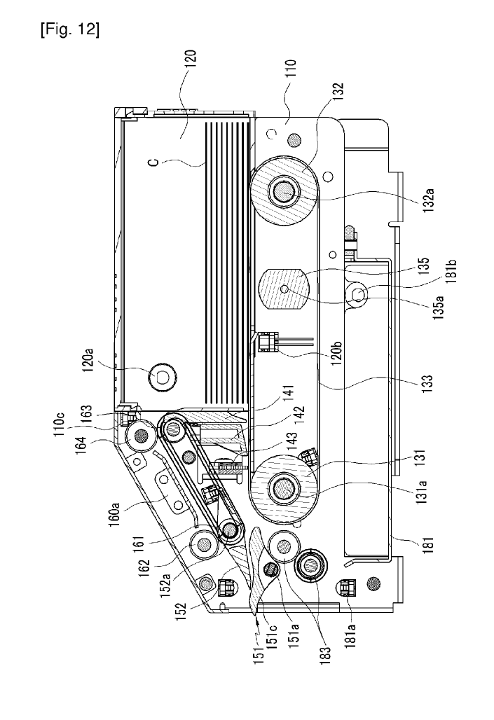

The transfer unit 130 (see FIG. 6 and FIG. 12) for issuing cards is provided beneath the card stacking box 120 to transfer the card at the bottom of the card stacking box 120 towards the card input and output portion 200 through the discharge slot 121.

The transfer unit 130 for issuing cards further include a main feeding roller 131 shaft-coupled 131a to the mounting frame 110 in a rotatable manner.

A sub-feeding roller 132 is shaft-coupled 132a to the mounting frame 110, at a constant gap with the main feeding roller 131, in a rotatable manner.

A transfer belt 133 is provided at the position connecting the main feeding roller 131 and the sub-feeding roller 132.

A fixed first pulley 134 (FIG. 6) is installed at the end of the main feeding roller 131.

A drive motor 135 (see FIG. 12) is installed on one side of the mounting frame 110 in a fixed manner.

A second pulley 136 is installed in a fixed manner on the rotating shaft 135a of the drive motor 135. In addition, a connection belt 137 is installed at the position connecting the first pulley 134 and the second pulley 136 (see FIG. 6).

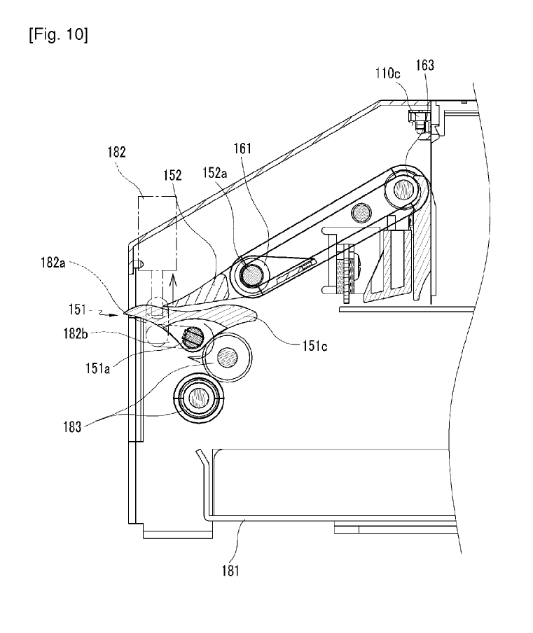

To feed the cards one at a time, the stoppers—first 141, second 142 and third 143 stoppers are installed in front of the card stacking box 120 at different vertical positions (see FIG. 9).

Firstly, the first stopper 141 is installed at a height allowing about three cards on the transfer belt 133 may pass through, and the second stopper 142 is installed at a height allowing about one card on the transfer belt 133 may pass through.

The third stopper 143 is configured to press the card elastically, so that the friction force between the card and the transfer belt 133 becomes stronger while the card is moving forward on the revolving transfer belt 133. As the result, only one card may be transferred.

Here, the mechanism is so configured as to make the second stopper 142 to be supported by the spring 142a elastically in a vertical direction, and the cards contact the slope 142b of the second stopper 142 while being fed forward.

The third stopper 143 made of a rubber material contacts the transfer belt 133 by a bracket 143a, and a card having passed the second stopper 142 is pushed forward by the rotation of the transfer belt 133 forming a gap to pass therethrough.

A first deflector 151 is shaft-coupled 151a to the mounting frame 110 in a rotatable manner in order to guide the card issued by the card transfer unit 130 to the card input and output portion.

A second deflector 152 contacting the upside of the first deflector 151 is shaft-coupled 152a (see FIG. 7) to the mounting frame 110 in a rotatable manner to enable collected cards to be stacked on top of the card stacking box 120 through the entry slot 122.

A card transfer unit 160 for collecting cards is installed on the inner side of the mounting frame 110 in a rotatable manner in order to transfer the cards guided by the second deflector 152 to stack them on top of the card stacking box 120 through the entry slot 122. Here, the second deflector 152 is mounted elastically by a spring 153 (see FIG. 6).

Inside the mounting frame 110 is provided with the sensors 110a, 110b, and 110c detecting the positions of cards being issued or collected and the sensors 120a and 120b monitoring the level of the cards in the card stacking box 120.

Describing the configuration of the card collecting transfer unit 160 in further detail, firstly, the first card collecting transfer roller 161 is installed on the shaft 152a of the second deflector 152.

A second transfer roller 162 for collecting cards is shaft-couple 162a to the mounting frame 110 in a rotatable manner, on the inner side, at a constant gap with the first transfer roller 161 for collecting cards.

A third transfer roller 163 for collecting cards is shaft-couple 163a to the mounting frame 110 in a rotatable manner, on the inner side, at a constant gap with the first and second transfer roller 161 and 162 for collecting cards and close to the entry slot 121 of the card stacking box 120

A fourth transfer roller 164 for collecting cards is shaft-couple 164a to the mounting frame 110 in a rotatable manner, on the inner side, at a constant gap with the third transfer roller 163 for collecting cards.

A feeding belt 165 is provided at the position connecting the first transfer roller 161 for collecting cards and the third transfer roller 163 for collecting cards.

The first, second, third and fourth transfer rollers 161 to 164 for collecting cards are driven by a drive unit 166.

The drive unit 166 is connected and interlinked with the card transfer portion 600. More particularly, the card transfer portion 600 is connected to the card transfer portion 600 by the pulleys P1 and P2 installed at the ends of the shafts 164a and 163a, respectively, and the connection belt V1 connecting them, and the card transfer portion 600 is connected to and driven by the drive unit 166.

Since the structure of a drive unit comprising multiple pulleys and connection belt is a commonly acknowledged technology, detailed description of the drive unit is eliminated.

Since erroneous cards which may occur in the processes of card issuing and collecting have to be removed to prevent malfunction of the device, an erroneous card removal unit 180 is further provided.

Describing the detailed configuration of the erroneous card removal unit 180, an erroneous cards stacking box 181 is provided beneath the mounting frame 110 to stack erroneous cards.

Sensors 181a and 181b are installed close to the erroneous cards stacking box 181 to check whether erroneous cards are entering the stacking box 181 or the stacking box is full.

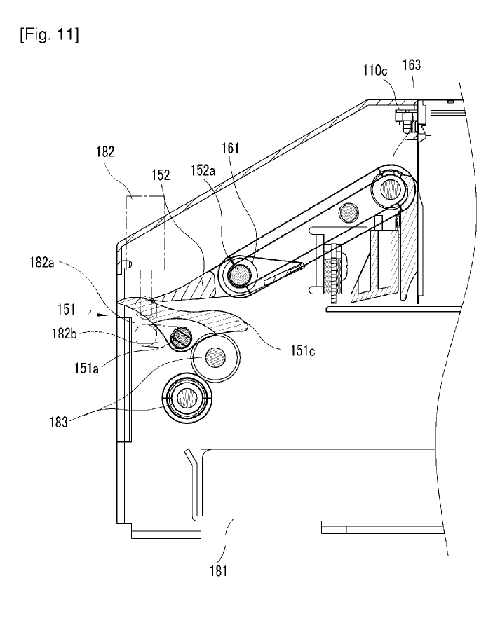

A solenoid is installed on the lateral side of the mounting frame 110, controlled by the controller 500 to guide the erroneous cards into the erroneous card stacking box 181 by rotating the first deflector 151 upwards centering the shaft 151a. The solenoid 182 and the shaft 151a are connected with two links 182a and 182b. Consequently, when the solenoid 182 is activated to pull in the direction of arrow, the shaft 151a rotates in the arrow direction (clockwise in the drawing) by the links 182a and 182b, rotating the first deflector 151 by a certain angle (see FIGS. 10 and 11).

A pair of erroneous card transfer rollers 183 are installed inside the mounting frame 110 in a rotatable manner, in order to transfer the erroneous cards, which are guided to the erroneous card stacking box 181 by the solenoid 182, into the erroneous card stacking box 181. The numbers 160a and 160b not described yet refers to a card guide plate and a PCB mounted with electric circuit elements, respectively.

For the gaming card processing device so configured as described above, the method of issuing and collecting cards in accordance with the present invention is described hereinbelow with reference to FIG. 23.

First, a player visits a casino (S3000), and buys a gaming card to play slot machine game (S3100).

The gaming card may be purchases at the information desk or unmanned kiosk which may sell gaming cards at a value paid by the purchaser in advance.

The player selects a slot machine (S3200), inserts the gaming card he/she has purchased (S3300) and plays game (S3300). As the game progresses, the value of the gaming card is increased or decreased according to the outcome of each game played.

When the player finishes gaming (S3500) the slot machine decides whether the value of the gaming card has been exhausted (all-in) or not (S3600). If the initial value has been exhausted, the slot machine collects the card with the gaming card processing device, which deletes all the information stored in the memory device of the card (S3700), and erases the data printed in the thermal printing layer on one side of the card (S3800). Then, the gaming card is transferred to and re-stored in the card stacking box of the gaming card processing device in the slot machine, and wait for next issuance (S3900).

If the initial value has not been exhausted, the card is transferred to the data processing portion (S4000) and the information (amount, time, gaming machine number, location, etc.) stored in the memory media of the card is changed (S4100).

Next, the card is transferred to the printing and erasing portion (S4200) which checks whether there is information printed in the thermal printing layer of the card (S4300). If the card has printed information on one side, the printing and erasing portion erases the printed data (S4350).

After the erasure, or there was no information printed on one side of the card, the printing and erasing portion prints changed information on one side of the card (S4400), and transfers the card to the card input and output portion (S4500), from which the card is issued to the player, completing the settlement (S4600).

Receiving the gaming card printed with changed information, the player may insert the card into another gaming machine to play games or cash the gaming card at the information desk or kiosk.

The operation of the gaming card processing device 1000 in accordance with the present invention is described in further detail hereinbelow.

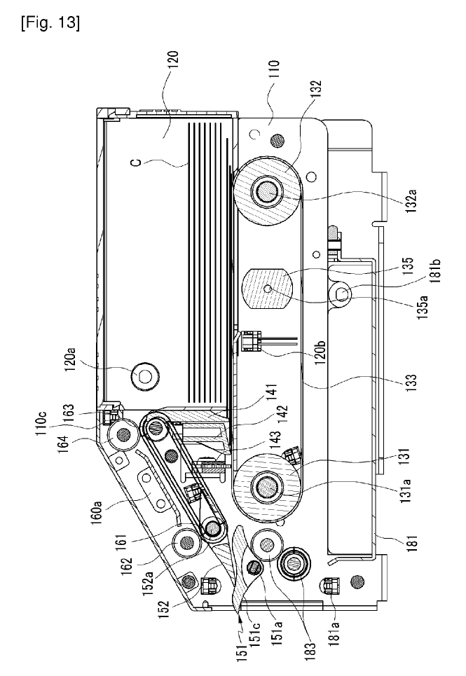

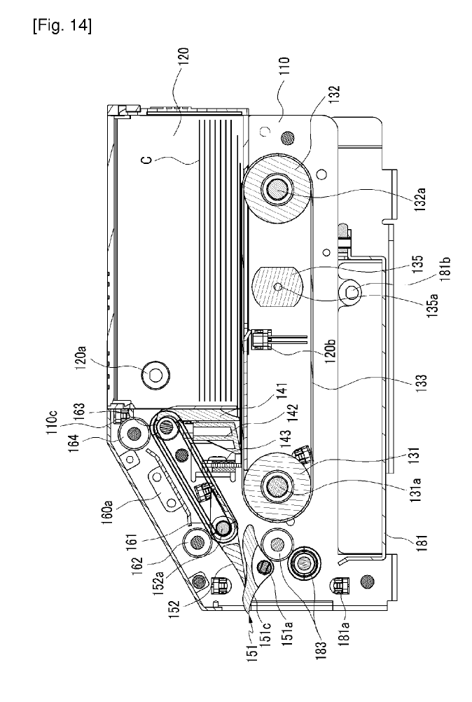

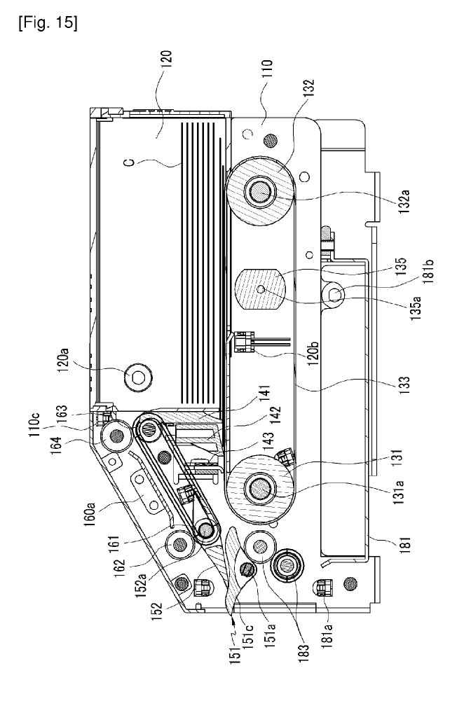

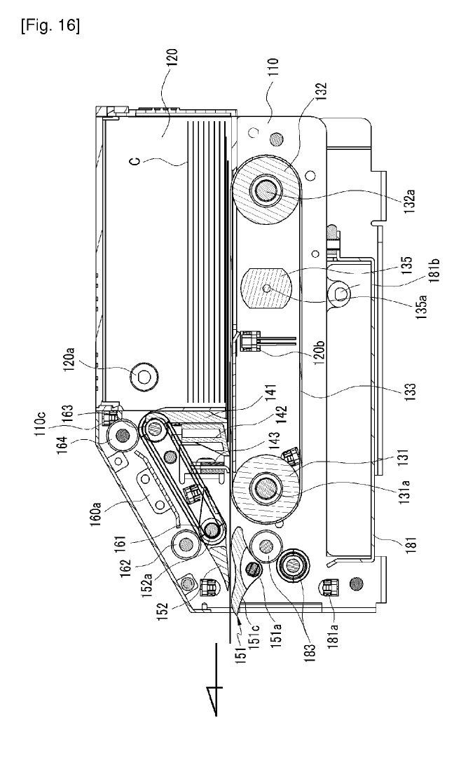

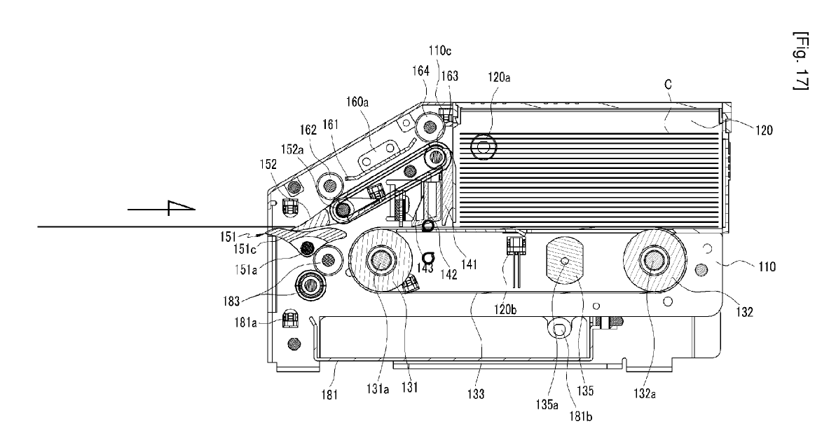

As shown in FIG. 12 to FIG. 16, to issue a card, the drive motor 135 rotates the second pulley 136 coupled with the rotating shaft 135a, and the second pulley 136 drives the main feeding roller 131.

The main feeding roller 131 drives the transfer belt 133 forward (arrow direction), followed by the sub-feeding roller rotating in the same direction.

Since the bottom of the card stacking box 120 is open, the card at the bottom is in contact with the transfer belt 133. As the transfer belt 133 moves forward (arrow direction), the card also moves forward through the discharge slot 121 of the card stacking box 120.

Since the first stopper 141 is positioned at about 0.7 mm above the transfer belt 133, about three cards may pass, and since the second stopper 142 is positioned at a height above the transfer belt 133 by about a thickness of card, only one card may pass through. The third stopper 143 contacts the transfer belt 133, and a card having passed the second stopper 142 is pushed forward by the revolution of the transfer belt 133 forming a gap to pass therethrough, resulting in passage of only one card.

There is the possibility that two cards pass through the second stopper 142 by static electricity between the cards. If two cards having passed through the second stopper 142 reach the third stopper 143 and push the third stopper 143 to secure space for passage, the upper card is checked by the third stopper 143 due to the elastic deformation of the third stopper 143, and the lower card is forced forward by the friction force with the transfer belt 133, separated from the upper card and discharged.

When the card having passed through the third stopper 143 reaches the first deflector 151 and moves further forward, the second deflector 152 rotates a little, elastically, centering the hinge 152a, by the spring 153. The card passes through the gap provided by the rotation of the second deflector 152, which then returns to the original position by the elasticity of the spring 153.

This discharge method may prevent machine errors and enhance the reliability of the product by having only one card, not a plurality of cards, issued (pass through) in a simple structure.

Having passed the first and second deflectors 151 and 152, the card is transferred by the drive motor of the card transfer portion 600, whose data are processed in the data processing portion 300, and discharged through the card input and output portion 200.

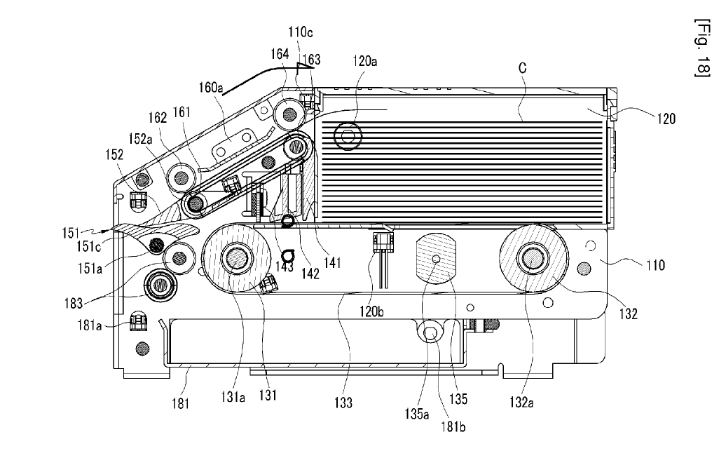

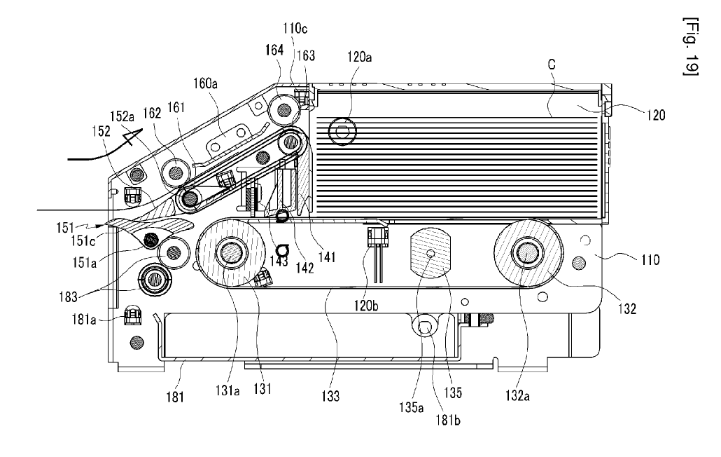

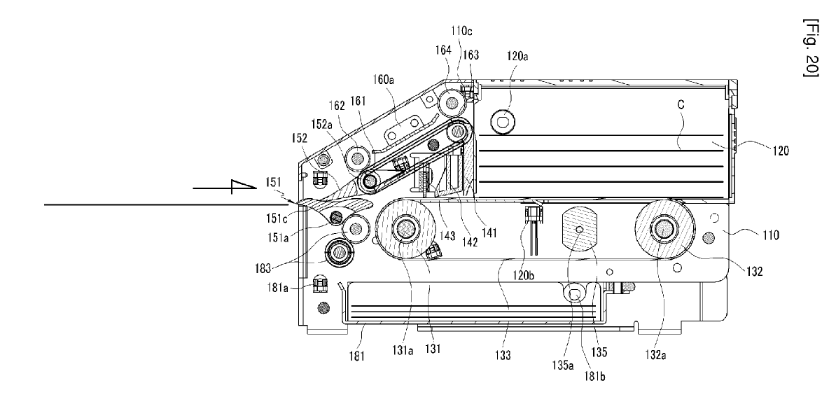

As shown in FIG. 17 to FIG. 19, to collect a card inserted into the card input and output portion 200 is transferred in the reverse direction of issuing by the reverse-direction rotation of the card driving part 600, whose data are processed in the data processing portion 300, and transferred to the card stacking device. Here, the main feeding roller 131, sub-feeding roller 132, and transfer belt 133 do not operate in reverse direction by a clutch bearing, and the 1^{st}, 2^{nd}, 3^{rd} and 4^{th} card collecting feeding rollers 161 to 164 operate.

The drive unit 166 interlinked with the card transfer portion 100′ rotates the 1^{st}, 2^{nd}, 3^{rd} and 4^{th} card collecting feeding roller 163 in arrow direction.

At the same time, maintaining contact with the first deflector 151 and second deflector 152 sequentially, the card changes its course upwards along on the slope 152b of the second deflector 152. After changing the course, the card passes through the entry slot 122 of the card stacking box 120 along on the feeding belt 165, and moves to the top of the box 120 and falls on the top of the card stack in the stacking box 120. This card collecting scheme enables stacking collected cards in the order of collection and issuing them also in their order of collection. Therefore, the cards are used in equal frequencies for about the same lifecycles.

In addition, the present invention may maintain the normal state of the device by eliminating erroneous cards quickly when a circumstance such as card jam, data recording error or card recognition failure occurs at the time of card issuing or collection.

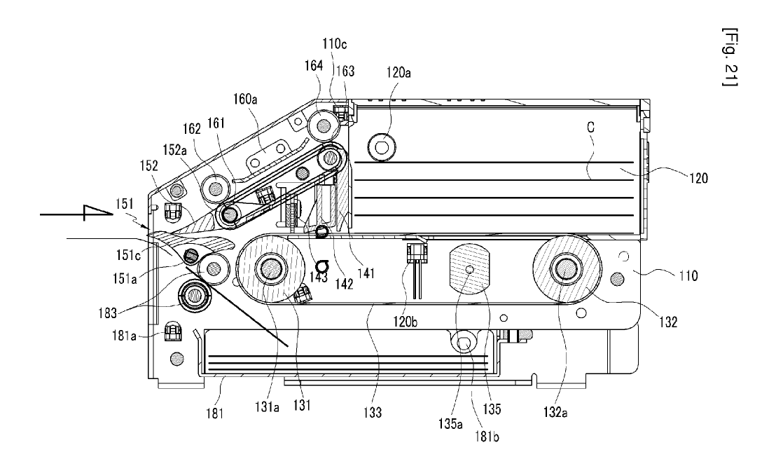

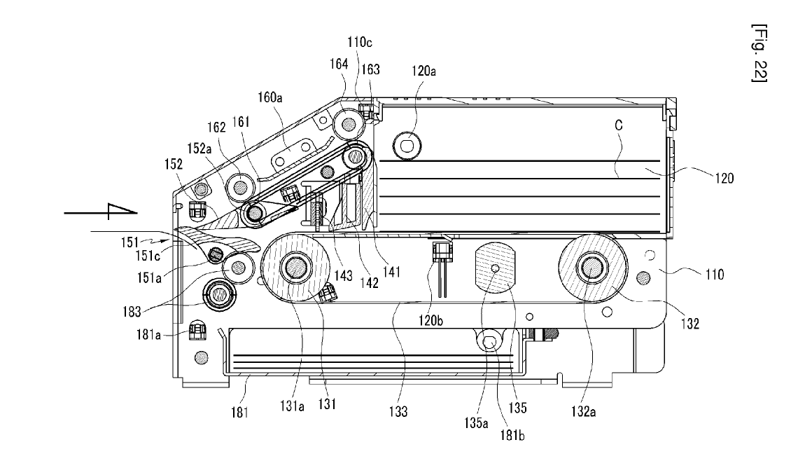

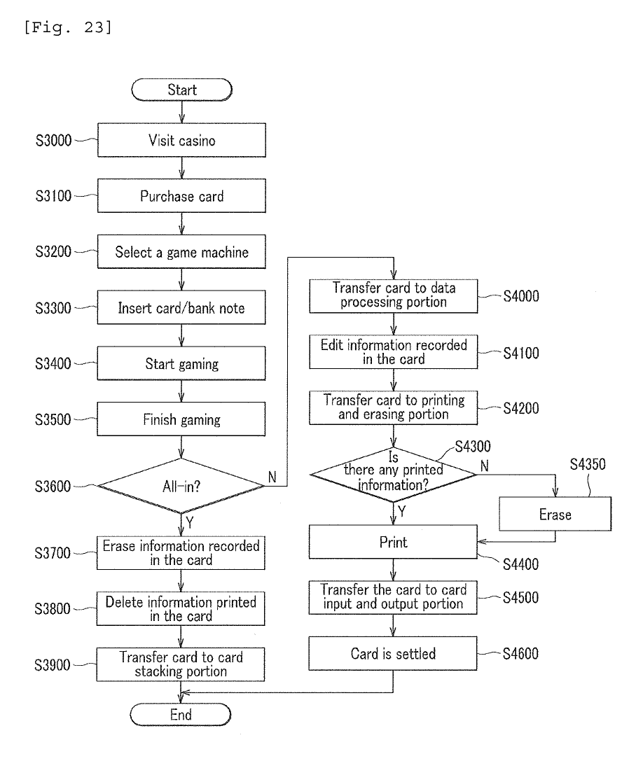

As shown in FIGS. 20 to 22, if there is an erroneous card, the solenoid 182 is activated and pulls and turns the first deflector 151 by a certain angle centering the shaft 151a.

By the first deflector 151, the second deflector 152 also turns by a certain angle centering the shaft 152a. Here, the card transferred in reverse direction by reverse operation of the card drive portion 600 changes its course downwards on the slope 151c of the first deflector 151.

After changing the course, the card is guided by a pair of transfer rollers 183 and stacked in the erroneous card stacking box 181.

After stacking, the solenoid 182 returns the first deflector 151 to its original position and the second deflector 152 also returns to its original position by the coil spring 153.

As described above, the present invention is configured such that a card which is collected first is issued first when collecting and issuing cards, and hence has the effect of improving the efficiency of card management and operation management by equalizing the frequency of card use.

Also, the present invention may prevent machine errors and enhance the reliability of the product by having only one card, not a plurality of cards, issued (pass through) at the time of issuing cards.

Also, the present invention may maintain the normal state of machine by eliminating erroneous cards quickly when a circumstance such as card jam, data recording error or card recognition failure occurs at the time of issuing or collecting cards.

In the above description, it would be apparent that the scope of the right of the present invention is not limited to the embodiment described above but defined by the accompanying claims, and that any person skilled in the art may implement the present invention in various ways within the scope of the rights stated in the claims.

The gaming card processing device 1000 in accordance with the present invention may be used to process (issue, read, collect, reissue) various kinds of cards, for example, slot machine cards, ID cards, registration cards, entry cards, and tickets, for the gaming machines of casino such as slot machines, and card terminals.

What is claimed is:

1. A gaming card processing device comprising; a card input and output portion, a data processing portion which records data into the cards, a printing and erasing portion which prints data on the cards and erases the printed data, a card transfer portion which transfers the cards, a controller which controls the operation of the device, and a card stacking portion which discharges stacked cards and re-stacks collected cards:
the card stacking portion further comprising: a mounting frame positioned behind the printing and erasing portion;
a card stacking box installed on the mounting frame in a detachable manner, stacked with cards inside, formed with a discharge slot in the bottom front for discharging cards, and formed with an entry slot in the upper front for collecting cards;
a transfer unit placed beneath the card stacking box to transfer the card at the bottom of the card stacking box to the card input and output portion;
the stoppers positioned in front of the card stacking box to allow only a single card is delivered;
a first deflector which is shaft-coupled to the mounting frame in a rotatable manner in order to guide the card issued by the card transfer unit to the card input and output portion;
a second deflector contacting the upside of the first deflector and shaft-coupled to the mounting frame in a rotatable manner to enable collected cards to be stacked on top of the card stacking box through the entry slot; and
a card transfer unit for collecting cards which is shaft-coupled to the inner side of the mounting frame in a rotatable manner in order to transfer the card guided by the second deflector to stack the card on top of the card stacking box through the entry slot.

2. The gaming card processing device of claim 1, wherein the data processing portion further comprises: a barcode recognizer which reads the barcode formed on one side of the card; a magnetic stripe processor which records data in the magnetic stripe formed on one side of the card or read and delete the data; and a radio frequency processor which records data in the IC chip embedded in the card or read and delete the data.

3. The gaming card processing device of claim 1,
wherein the transfer unit for card issuing further comprises: a main feeding roller which is shaft-coupled to the mounting frame in a rotatable manner;
a sub-feeding roller which is shaft-coupled to the mounting frame in a rotatable manner maintaining a constant gap from the feeding roller;
a transfer belt connecting the main feeding roller and the sub-feeding roller;
a first pulley mounted and fixed at the end of the main feeding roller; a drive motor mounted and fixed on the mounting frame;
a second pulley fixed to the rotating shaft of the drive motor; and
a connecting belt connecting the first and second pulleys.

4. The gaming card processing device of claim 1, wherein the transfer unit for collecting cards further comprises:
a first transfer roller which is connected to the shaft of the second deflector for colleting cards;
a second transfer roller for collecting cards, the second transfer roller being shaft-couple to the mounting frame inside in a rotatable manner at a certain gap with the first transfer roller for collecting cards;
a third transfer roller for collecting cards, the third transfer roller being shaft-couple to the mounting frame inside in a rotatable manner at a certain gap with the first transfer roller for collecting cards and close to the entry slot of the card stacking box;
a fourth transfer roller for collecting cards, the fourth transfer roller being shaft-couple to the mounting frame inside in a rotatable manner at a certain gap with the third transfer roller for collecting cards;
a feeding belt connecting the first transfer roller for collecting cards and the third transfer roller for collecting cards; and
a drive unit driving the first, second, third and fourth transfer rollers for collecting cards.

5. The gaming card processing device of claim 1, wherein inside of the mounting frame is provided with the sensors detecting the positions of cards being issued or collected and the sensors monitoring the level of the cards in the card stacking box.

6. The gaming card processing device of claim 1, wherein the gaming card processing device further comprises an erroneous card removal unit to remove the erroneous cards which may occur in the process of issuing or collecting cards.

7. The gaming card processing device of claim 6, wherein the erroneous card removal unit further comprises: a stacking box positioned beneath the mounting frame to stack erroneous cards;
a solenoid installed on the lateral side of the mounting frame, controlled by the controller to guide the erroneous cards into the erroneous card stacking box by rotating the first deflector upwards centering the shaft; and
a pair of erroneous card transfer rollers which are shaft-coupled to the inside of the mounting frame in a rotatable manner, in order to transfer the erroneous cards, which are guided to the erroneous card stacking box by the solenoid, into the erroneous card stacking box.

8. The gaming card processing device of claim 7, wherein inside of the mounting frame is provided with the sensors detecting the positions of the erroneous cards being collected and the sensors monitoring the level of the cards in the erroneous card stacking box.

9. The gaming card processing device of claim 1, wherein the stoppers comprise the first, second, and third stoppers in front of the card stacking box so that the cards may be delivered one by one, without overlapping, from the card stacking box to the card input and output portion.

10. The gaming card processing device of claim 1, wherein the first deflector moves up and down by a solenoid and the second deflector is mounted elastically by a spring.

11. The gaming card processing device of claim 1, wherein the card stacking portion functions as a component of the gaming card processing device providing first-in-first-out functionality and so configured as to be usable as an independent card issuing and collecting device (card dispenser).
